(19) United States
(12) Patent Application Publication
(10) Pub. No.: US 2008/0022796 A1
(43) Pub. Date: Jan. 31, 2008

(54) Steering apparatus equipped with ring type support yoke

(75) Inventors: Jun Hyuk Kim, Wonju (KR); Ji Yeol Kim, Wonju (KR)

Correspondence Address: LAHIVE & COCKFIELD, LLP, ONE POST OFFICE SQUARE, BOSTON, MA, 02109-2127, US

(73) Assignee: Mando Corporation, Pyeongtaek-si (KR)

(21) Appl. No.: 11/827,452

(22) Filed: Jul. 11, 2007

(30) Foreign Application Priority Data
Jul. 25, 2006 (KR) 2006-69680

(51) Int. Cl. B62D 3/12

(52) U.S. Cl. 74/422

(57) ABSTRACT

A steering apparatus having a ring type support yoke is provided. The apparatus includes a rack bar provided with a rack gear at one side of the outer circumference thereof, a support provided on the other side of the outer circumference of the rack bar, and a support yoke surrounding the rack bar so as to come into contact with the support, thereby reducing manufacturing costs of the steering apparatus through reducing the number of the parts supporting the support yoke, and shortening the manufacturing period of the steering apparatus through dispensing with the adjusting process for adjusting the degree of engagement between the rack gear and the pinion gear.

### RELATED APPLICATIONS

This application claims priority to Korean patent application No. KR2006-69680 filed on Jul. 25, 2006, the content of which is incorporated by reference.

### FIELD OF THE INVENTION

The present invention relates to a steering apparatus equipped with a ring type support yoke, and more particularly to a steering apparatus equipped with a ring type support yoke surrounding and supporting a rack bar at multiple points, thereby reducing the number of the parts and shortening a manufacturing process.

### BACKGROUND OF THE INVENTION

A steering apparatus of an automobile is an apparatus for allowing a driver to change the center of rotation of the front wheels of an automobile, guiding the automobile to a direction desired by the driver.

FIG. 1 is a schematic view of a steering apparatus according to the prior art.

As shown in FIG. 1, the steering apparatus of the prior art includes a pinion axis 103 rotating together with a steering wheel 101 while a driver rotates the steering wheel 101, and a rack bar 107 connected, at both ends, to driving wheels 105 so as to linearly move along with the rotation of the pinion axis 103.

A pinion gear 109 is provided on the outer circumference of the pinion axis 103, and a rack gear 111 is provided on one side of the outer circumference of the rack bar 107 so as to be engaged with the pinion gear 109.

Thus, the rack bar 107 linearly moves in an axial direction according to the rotation of the pinion axis 103, so that the direction of both driving wheels 105 is changed. That is, a driver can guide an automobile to a desired direction through the pinion axis 103 and the rack bar 107.

Meanwhile, if the engagement between the pinion gear 109 and the rack gear 111 becomes loose, problems are caused in that the rotational force of the pinion axis 103 cannot be smoothly transferred to the rack bar 107, and noises or vibrations occur. Thus, the engagement between the pinion gear 109 and the rack gear 111 should be firmly maintained through pushing the rack bar 107 against the pinion axis 103.

FIG. 2 is a partial exploded perspective view illustrating a support yoke according to the prior art.

As shown in FIG. 2, the support yoke 201 has both ends, the front end being recessed so as to come into contact with the outer circumference of the rack bar 107, the rear end being supported by a yoke spring 203 and a yoke plug 205.

The yoke plug 205 has a threaded outer circumference which is engaged with a rack housing 207. A lock nut 209 is provided at the rear end of the yoke plug 205 so as to prevent the yoke plug 205 from being detached from the rack housing 207.

According to the prior art having the above construction, when the yoke plug 205 is moved forward or back, the pressure applied to the rack bar 107 by the yoke spring 203 can be changed, and finally the degree of engagement between the rack gear 111 and the pinion gear 109 can also be regulated.

However, the prior art has the following problems.

First, many parts are needed such as the yoke spring, the yoke plug or the like for supporting the support yoke, thereby increasing the manufacturing costs of the steering apparatus.

Moreover, an adjusting process is needed for adjusting the degree of engagement between the rack gear and the pinion gear after assembling the support yoke, thereby extending the manufacturing period of the steering apparatus.

### SUMMARY OF THE INVENTION

Accordingly, the present invention has been made to solve the above-mentioned problems occurring in the prior art, and an object of the present invention is to reduce manufacturing costs of a steering apparatus through reducing the number of the parts supporting a support yoke.

Another object of the present invention is to shorten the manufacturing period of a steering apparatus through dispensing with an adjusting process for adjusting the degree of engagement between a rack gear and a pinion gear.

In accordance with an aspect of the present invention, there is provided a steering apparatus including: a rack bar provided with a rack gear at one side of the outer circumference thereof; a support provided on the other side of the outer circumference of the rack bar; and a support yoke surrounding the rack bar so as to come into contact with the support.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view of a steering apparatus according to the prior art;

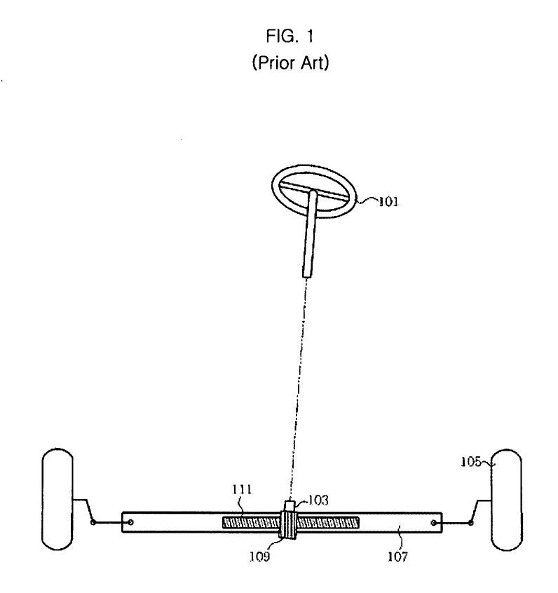

FIG. 2 is a partial exploded perspective view illustrating a support yoke according to the prior art;

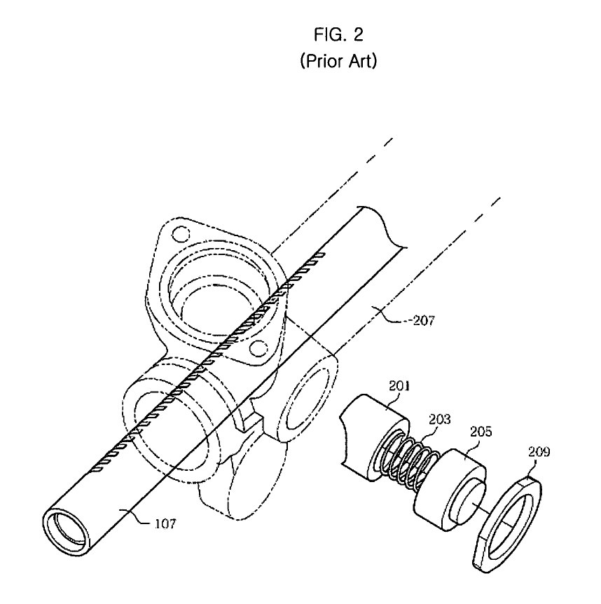

FIG. 3 is a partial perspective view of a steering apparatus of an automobile according to a preferred embodiment of the present invention; and

FIG. 4 is a sectional view taken along line A-A of FIG. 3.

### DETAILED DESCRIPTION OF THE EXEMPLARY EMBODIMENTS

Hereinafter, exemplary embodiments of the present invention will be described with reference to the accompanying drawings. In the following description and drawings, the same reference numerals are used to designate the same or similar components. Further, in the following description of the present invention, a detailed description of known functions and configurations incorporated herein will be omitted when it may make the subject matter of the present invention rather unclear.

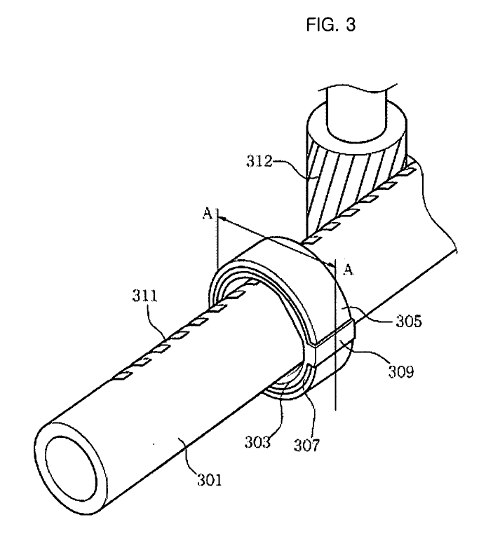

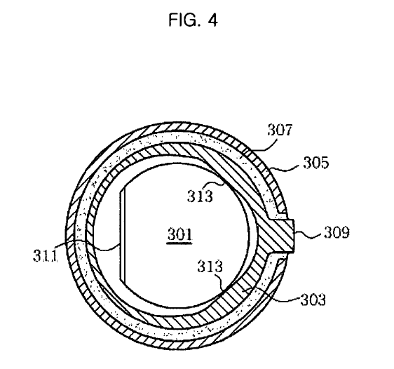

FIG. 3 is a partial perspective view of a steering apparatus of an automobile according to a preferred embodiment of the present invention, and FIG. 4 is a sectional view taken along line A-A of FIG. 3.

As shown in FIG. 3, the steering apparatus of an automobile includes a cylindrical rack bar 301, a support yoke 303 surrounding the rack bar 301, a bush 305 surrounding the support yoke 303, a resilient member 307 provided between the support yoke 303 and the bush 305, and a protrusion 309 formed on the outer circumference of the support yoke 303.

A rack gear 312 is formed on one side of the outer circumference of the rack bar 301 so as to be engaged with the pinion gear 312, and a support 313 is formed on the other side so as to come into contact with the inner circumference of the support yoke 303. The support 313 may be formed with two or more ones, and a part of the outer circumference of the rack bar 313 may protrude, but it is not limited thereto. In addition, the support 313 may be formed by planarizing the outer circumference of the rack bar 301.

The support yoke 303 is formed like a ring surrounding the rack bar 301 such that the inner circumference thereof comes into contact with the support 313, supporting the other side of the rack bar 301. That is, one side of the rack bar 301 is supported by the pinion gear 312, and the other side thereof is supported by the support yoke 303.

In addition, a portion of the inner circumference of the support yoke 303 contacting the support 313 may be formed such that it protrudes to a certain level.

Thus, contrary to the prior art, the present invention does not need additional separate parts supporting the support yoke 303, reducing the number of parts and the manufacturing costs of the steering apparatus.

Meanwhile, since the support 313 is formed on the outer circumference of the rack bar 301 parallel with the axial direction of the rack bar 301, it is supported by the support yoke 303 when the rack bar 301 linearly moves in the axial direction, or even does not linearly move. Although the number of the support 313 is preferably two as shown in FIG. 4, it is not essentially limited thereto.

As seen above, according to the present invention, after the support yoke 303 is installed on the rack bar 301, the pinion gear 312 is made engaged with the rack gear 311, so that unlike the prior art, the adjusting process for adjusting the degree of engagement between the rack gear and the pinion gear through the adjustment of the yoke plug is not needed.

The bush 305 is formed to surround the outer circumference of the support yoke 303, and the resilient member 307 is provided between the support yoke 303 and the bush 305. Thus, noises or vibrations possibly occurring between the rack gear 111 and the pinion gear 312 can be absorbed by the resilient member 307. Meanwhile, the resilient member 307 may be rubber, but it is not limited thereto.

The protrusion 309 is formed on the outer circumference of the support yoke 303 opposite to the rack gear 311, so that when installing the support yoke 303 on the rack bar 301, an operator can check the direction of the rack gear 311 with his/her own eyes, thereby preventing the support yoke from being installed in a misdirection.

Meanwhile, the resilient member 307 preferably extends up to the midway between the protrusion 309 and the bush 305, but it is not limited thereto.

As set forth before, the present invention provides an effect of reducing manufacturing costs of the steering apparatus through reducing the number of the parts supporting the support yoke.

Further, the present invention provides an effect of shortening the manufacturing period of the steering apparatus through dispensing with the adjusting process for adjusting the degree of engagement between the rack gear and the pinion gear.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A steering apparatus comprising:
a rack bar provided with a rack gear at one side of the outer circumference thereof;
a support provided on the other side of the outer circumference of the rack bar; and
a support yoke surrounding the rack bar so as to come into contact with the support.

2. The steering apparatus as claimed in claim 1, wherein an inner circumference of the support yoke contacting the support protrudes to a certain level.

3. The steering apparatus as claimed in claim 2, wherein a bush is provided to surround the support yoke.

4. The steering apparatus as claimed in claim 3, wherein a resilient member is provided between the outer circumference of the support yoke and an inner circumference of the bush.

5. The steering apparatus as claimed in claim 4, wherein the outer circumference of the support yoke is provided, at one side, with a protrusion.

6. The steering apparatus as claimed in claim 5, wherein the resilient member extends up to a midway between the protrusion and the bush.

7. The steering apparatus as claimed in claim 1, wherein the steering apparatus comprises two supports.
